(19) United States
(12) Patent Application Publication
(10) Pub. No.: US 2016/0189468 A1
(43) Pub. Date: Jun. 30, 2016

(54) RANDOM OUTCOME CUSTOMER AWARDS

(71) Applicant: Jamie Abahamson, Las Vegas, NV (US)

(72) Inventor: Jamie Abahamson, Las Vegas, NV (US)

(21) Appl. No.: 14/941,593

(22) Filed: Nov. 14, 2015

Related U.S. Application Data
(60) Provisional application No. 62/080,146, filed on Nov. 14, 2014.

(51) Int. Cl. G07F 17/32

(52) U.S. Cl. CPC G07F 17/329

(57) ABSTRACT

A method provides random potential award identifiers to users by: a) a primary client enabling provision of game cards having a potential for obtaining awards based on random event outcomes; b) the primary client establishing a supply system for the users to obtain the game cards; c) the user engaging in the supply system and obtaining a unique identification code enabling access to a client controlled source of game cards; d) the user accesses a distal server and enters the unique identification code; e) the distal server provides a randomly generated game card having a potential for obtaining awards based on random event outcomes without the user exchanging value to obtain generated game card; f) information is provided to the distal server of random event outcomes; and g) the server identifies outcomes based on a comparison of content on the randomly generated game card and the random event outcomes.

### RELATED APPLICATION DATA

This Application claims priority from U.S. Provisional Patent Application Ser. No. 62/080146, filed 14 Nov. 2015 and titled “RANDOM OUTCOME CUSTOMER AWARDS.”

### BACKGROUND OF THE INVENTION

1. Field of the Invention

The present invention relates to the field of customer or consumer awards, and in particular, customer or consumer awards in the form of tickets, icons or electronic images that offer a potential value depending upon outcomes in events. Methods of providing the customer or consumer awards and identifying achieved value based upon third party events are also enabled.

2. Background of the Art

In modern commerce, it has become important for stores, events, restaurants, theaters, venues and other consumer-oriented businesses to provide client recognition and to provide clients with rewards or potential awards to stimulate their loyalty and business. One common practice is to award stamps, coupons, stickers or game pieces to customers that make purchases or particular purchases. An example of this is the MacDonald's contests (e.g., Monopoly® board game) and in 2012, an Olympic Games® event game ticket. In the latter, upon purchase of special items, game tickets were given to the client identifying specific winning outcomes, such as either a particular National Team event (e.g., U.S. Men's gymnastic team), particular event and country (e.g., Canada 1000 m men's race cycling) or an individual or individual in a specific event (e.g., Australia women in the 200 m butterfly, or Michael Phelps in the Men's 200 m Individual Medley, or Missy Franklin, Bronze medal in the Women's 100 m Backstroke). These tickets were generally given out weeks or days before the events took place, increasing the possibility of their being lost before the potential for value or determination of no value was made. Also, the tickets were randomly provided with no client input as to general event selection (all tickets were for the 2012 Olympic Games® events), specific variety of sports event (tickets were randomly provided without any capability of selecting a particular sport event (e.g., swimming, equestrian events, track and field, water polo, etc.). This can reduce the interest in the client who might not appreciate competition in the event on his/her card, such as boxing. Additionally, because the tickets had little relevance to real time events, such unforeseen events such as countries pulling out of or being barred from the Olympics, or injuries to players well in advance if the events removed any interest in certain picks.

Other award programs can be performed on-line or at point of sales. For example, Published U.S. Patent Document No. 20140229263 (Edelman) discloses a method of providing a loyalty rewards program, comprising receiving an electronic order for a purchase of goods or services from a personal communication device operated by a consumer over a communication interface, determining a location of the personal communication device, electronically awarding rewards points by a processor to an account associated with the consumer stored in memory based on purchases of goods or services placed through the personal communication device by the server only if the personal communication device is located at a merchant's premises, the merchant authorized to participate in the loyalty rewards program.

Published U.S. Patent Application Document No. 20140222540 (Shepard) discloses a platform for a loyalty program provides an interface allowing a consumer to create a benefit tailored for his/her needs. In one embodiment, a consumer accesses the platform via a web-based interface, and selects benefit/reward parameters including but not limited to the nature of the event triggering award of the benefit, the source (i.e. retailer) of the benefit, the nature of the benefit (i.e., discount based upon purchase price or accumulated loyalty points), and/or the events allowing accrual of loyalty points. The interface communicates the inputted parameter to an engine of the loyalty program. The platform would then check the inputted parameter against any constraints, such as parameters of an existing loyalty program in which the consumer is already enrolled.

Published U.S. Patent Application Document No. 20140222533 (Ovick) discloses an individualized price offer is associated with the account information of a user in a data warehouse coupled with a transaction handler of a payment processing network. If the individualized price offer is applicable for a pre-authorization of a purchase, information about the price offer is communicated to a transaction terminal via an authorization response for the pre-authorization. The transaction terminal is configured to adjust the published price in accordance with the information about the price offer such that the user is presented with an individualized price at the transaction terminal before the user starts receiving the product or service. After the purchase, the transaction terminal computes the transaction amount according to the individualized price and request clearing and settlement of the transaction according to the transaction amount computed according to the individualized price.

Published U.S. Patent Application Document No. 20140228088 (Katz) Methods and systems for electronic interaction comprising a display for presenting a grid of identifying objects, an input for receiving a player selection of an identifying object, a random generator for randomly selecting a winning identifying object, and a point tally system for awarding points to the player according to the rules comprising a first point value if the player selected identifying object exactly matches the winning identifying object, a second point value if the player selected identifying object is in a geometric relationship with the winning identifying object, and a third, negative, point value if the player is not awarded the first point value or the second point value.

Published U.S. Patent Application Document No. 20140057707 (Paulsen) discloses data processing apparatus, systems, and methods implemented over a gaming network for providing for disposition of promotional offers in a wager-based gaming environment. A monitoring engine receives an identification of a promotional offer as having an unredeemed status. A determining engine determines that the promotional offer having the unredeemed status satisfies one or more parameters to designate the promotional offer for an auction. Such designation is independent of real-time wager-based game play in the gaming network. An auction control engine provides the designated promotional offer as an item to be auctioned in the wager-based gaming network.

Published U.S. Patent Application Document No. 20130035149 (Oakes) describes systems and methods for retail lottery-style games. In one particular exemplary embodiment, a map-based lottery game is established, by at least one processor, that is scheduled to have a lottery drawing, where the map-based lottery game includes a gameboard made up of a plurality of units each selectable to represent an entry in the lottery game. In addition, a plurality of game entries are received each identifying a unit on the gameboard either with an identifier of the unit or with a lottery combination corresponding to the unit and, at least one winning entry from the plurality of game entries is selected by selecting among the plurality of units on the gameboard or among the units identified by the plurality of game entries.

Published U.S. Patent Application Document No. 20120270642 (Manfredi) describes a gaming machine award system that acts over a gaming machine network having a plurality of gaming devices coupled thereto. The award system includes a bonus server coupled to the network and having stored thereon a trigger condition. A game play tracker tracks game play across the network of gaming devices and detects an occurrence of the trigger condition. The bonus server sends out a selection signal over the network to a selected gaming machine responsive to the detected trigger condition. A printer associated with the selected gaming machine is structured to generate a mystery ticket printed output responsive to receipt of said selection signal including machine-readable indicia corresponding to a record of value stored at the bonus server, and human readable indicia that indicates only a range of possible values of the ticket but not a specific value. The printed ticket is a cashless instrument that may be redeemed or played per the nature and characteristics of the award given with the specific value awarded to the player.

Published U.S. Patent Application Document No. 20120061951 (Upshaw) discloses systems, methods, and lottery tickets provide lottery games with gameplay that allows a variety of play options and results a rich prize structure. Gameplay can be centered on a lottery game player or a related entity, which can comprise other lottery game players. Gameplay centered on the lottery game player can be customized to a specific segment associated therewith. Play options can include iterative gameplay and gameplay reliant on information supplied by the game player. Features of the rich prize structure include monetary prizes that can include cash awards and non-cash awards. Monetary prizes can be awarded in response to active game play or passive gameplay. Other monetary prizes can be redeemed during a period of time and can include award terms that benefit the lottery game player or the related entity (relative(s) of the lottery game player, non-profit organization(s), prize supplier(s), etc.). In spite of the potential interest of these gaming systems, which disclosures are incorporated by reference in their entirety, a more interesting and effective award system is still needed.

### SUMMARY OF THE INVENTION

A method and system provides random potential award identifiers to users without purchase by:
a) a primary client enabling provision of game cards having a potential for obtaining awards based on random event outcomes;
b) the primary client establishing a supply system for the users to obtain the game cards;
c) the user engaging in the supply system and obtaining a unique identification code enabling access to a client controlled source of game cards;
d) the user accesses a distal server and enters the unique identification code;
e) the distal server provides a randomly generated game card having a potential for obtaining awards based on random event outcomes without the user exchanging value to obtain the randomly generated game card;
f) information provided to the distal server of random event outcomes; and
g) the server identifying winning or losing outcomes based on a comparison of information content identified on the randomly generated game card and the random event outcomes.

### BRIEF DESCRIPTION OF THE FIGURES

FIG. 1 illustrates one embodiment of a system for providing award cards, award tickets and/or accumulated value from winning event outcomes, which might otherwise be considered as incentive rewards or loyalty points, to consumers who are located on the premises of a merchant participating in a reward program;

FIG. 2 is a functional block diagram of one embodiment of one of the servers shown in FIG. 1 in an embodiment where the server acts as a rewards points server and another server acts as a point-of-sale server;

FIG. 3 is a functional block diagram of one embodiment of one of the personal communication devices shown in FIG. 1.

FIG. 4A is a sample of a Parlay Game card that may be a ticket or an image.

FIG. 4B is a math analysis of the Parlay Game card of FIG. 4A.

FIG. 4C shows additional math analyses for Parlay Game cards different from that in FIG. 4A.

FIG. 4D shows a sample Randomly Generated Fantasy Card.

FIG. 4E is a math analysis of the Fantasy Game card of FIG. 4D.

FIG. 4F is a sample of a Randomly Generated Bingo-type Game card.

FIG. 4G is a math analysis of a Randomly Generated Bingo-type Game card as in 4F.

FIG. 4H is a sample of a Randomly Generated Game Box card.

FIG. 41 is a math analysis of a Randomly Generated Game Box card as in 4H.

FIG. 5A is a sample of a random draw of four players (the Virtual Foursome), a list of exemplary prizes and a separate indication of probabilities in outcomes.

FIG. 5B is a partially completed scorecard for the virtual foursome at a tournament.

FIG. 6 is a screen shot of an electronically transmitted award.

FIG. 7 is schematic of a process within the scope of the present generic technology.

### DETAILED DESCRIPTION OF THE INVENTION

A method and system provides random potential award identifiers to users without purchase by: a) a primary client enabling provision of game cards having a potential for obtaining awards based on random event outcomes; b) the primary client establishing a supply system for the users to obtain the game cards; c) the user engaging in the supply system and obtaining a unique identification code enabling access to a client controlled source of game cards; d) the user accesses a distal server and enters the unique identification code; e) the distal server provides a randomly generated game card having a potential for obtaining awards based on random event outcomes without the user exchanging value to obtain the randomly generated game card; f) information provided to the distal server of random event outcomes; and g) the server identifying winning or losing outcomes based on a comparison of information content identified on the randomly generated game card and the random event outcomes.

The method and system is especially effective wherein the information content is selected from random event outcomes that are random or partially directed sports event outcomes or statistics that are of a relatively immediate outcome nature. By random sports outcomes are meant there is a processor (local or distal) that accesses a data base on at least one but preferably more than one sports events such as games, or halves or innings, or quarters or event individual plays (next at bat, next series of downs, next play, next field goal attempt, next possession, etc.) as with professional or collegiate baseball, football, soccer, hockey, horse racing, automobile racing, track and field and other competitive sports. “Partially directed” sports events means that a client may select a particular sport, particular sport event or particular game on which the processor will access a data base and select random events, the outcomes of which will be used to determine potential value for a physical or electronic ticket. “Relatively immediate” means that the outcome of the randomly selected event(s) will be determined in a time frame commensurate with the business that is providing the physical or electronic tickets. For example, the longest time period within a relatively immediate framework may be 24 hours (might be a week for a parlay card, for a week of football games, etc.), but more likely, as with a theme park or stadium, a relatively immediate time frame may be events that are absolutely concluded within a next 12 hours, or within a next six hours. For shorter duration business models, such as theaters, restaurants, malls, outlets and the like, a relatively immediate time frame may be less than 12 hours, such as less than 9 hours, less than 6 hours, less than 5 hours, less than 4 hours, less than 3 hours, less than 2 hours, less than 90 minutes, less than 1 hour or even less than 30 minutes. The time interval is significant in overcoming the problems of providing outcome tickets that are pre-printed well in advance of potential events. For example, if tickets had been printed before the 1980 Olympics, the boycott by the (then) USSR, would have substantially invalidated tickets where a Russian athlete was on the ticket, or increased the probability for an athlete whose importance increased because of the absence of Russian competitors. As such tickets would have been made with a predictable percentage of wins versus losses, events changing so far after issuance of the tickets can dramatically change award levels.

By accessing an electronic data base of sports information, especially those with live feeds of sports data, outcome results of events in near real-time play can be reported, and where a particular event is accessible by visual viewing (by television, live streaming or other display, including live attendance), customers can observe events and enjoy the excitement of at least one of their randomly selected events on which an outcome can determine a winning outcome on their ticket. For example, the ticket may indicate one or more events on which a winning outcome will be determined.

A ticket for a baseball game might say that the next at bat on 15 Aug. 2014 for Joe Mauer of the Minnesota Twins versus the New York Yankees will result in a walk. That ticket would be in a time frame only within the relatively immediate time frame so that the outcome can be determined. For example, that ticket might be issued during the actual time when the game is being played, with a date stamp (physical and electronic) identifying the time when the ticket was issued so that the appropriate at-bat will be used in the determination of the event outcome. The ticket may also have multiple event outcomes from that particular sports event, multiple related sports events or multiple random sports events with a relatively immediate time frame. For example, in the Twins versus Yankees game identified, there may be two, three, four, five or more events identified (e.g., up to and including a Bingo time card with five rows and five columns) with individual event outcomes identified.

An award may be based upon successful outcomes on events, with no reward or higher levels of awards provided with increasing numbers of successful event outcomes. For example, at a restaurant, a randomly selected ticket may include outcomes of 1) Twins win game in no more than 9 innings, 2) Yankees have at least 10 hits, and 3) total collective runs scored in the game will be fewer than 4. These randomly selected events would be absolutely determined by the end of the game. A client at the restaurant (especially Sports Bar) would be enticed to stay longer at the restaurant to have the outcome determined while he was there. The awards might be a non-alcoholic beverage for the winning outcome of 1), a beer for a winning outcome for 2), a free appetizer from a defined selection for a combination of 1) and 2), and a free meal from a limited selection from 1), 2) and 3) having winning outcomes. The partially directed method would have the user select a general field of sports or a specific game of interest within a sports category (without actually selecting a specific outcome). This might be done because at different times of the year the promotion would most likely be geared to a specific sport already, as that might be the only sport in play on that day. For example, the client may select the Twins versus the Yankees, and the processor would then make random selections of potential individual event outcomes that could occur in that game.

Some of the outcomes might be contradictory, such as Twins win and Yankees win as separate event outcomes determining the ticket overall outcome (on the same ticket or not). The selection of random events or outcomes is done without the client being allowed to select the specific event outcomes or statistic. Preferred client selectable fields are a general field selected from the group consisting of football, basketball, baseball, hockey, soccer, golf, and tennis. As noted above, the method may use event outcomes or statistics within the general field that must be determined within a reasonable time frame. In rare circumstances the relatively immediate time frame may be a single week of play for football, a weekend total of baseball games, and may be required to have a final determination within 48 hours, 36 hours, 24 hours and the like from the issuance of the ticket (or maybe up to a week for the above mentioned football week, with the tickets or coupons given within two days before the beginning of the next football week in a season). As previously noted, event outcomes or statistics within the general field preferably will be determined within 24 hours of award of random game cards (although not if it is for football games that might span a week, although this is a less preferred embodiment for reasons provided herein). The primary client may be a retailer, wholesaler, restaurant, theater, sports venue operation, stadium, track, pool, university, school or online sales business (it might also be a sports venue operator, for example the owner of a sports team or venue doing a promotion for fans at the stadium, arena, track, etc.

The method may be practiced where the user resolves the randomly awarded game ticket by online communication to the server after conclusion of the random event outcomes and resolution of winning outcomes is provided by online downloadable or printable coupons that can be redeemed (again as long as this not limiting to the only method of resolving a winning ticket), or by scanning a bar code or QRL on the ticket.

A significant and unique difference in using real time sports lines (handicapping) and sports data to create the randomly generated game cards (at the time that the game card is randomly generated, it is using real time odds and data) is that the random generation of the tickets may embed changes to control the ultimate payout value of tickets. Thus if the Twins were presently 5 runs up, offering events for determining outcomes in which the Yankees win in nine innings has a lower potential value. The processor can determine precise probability(s) of winning each prize even though they are based on random live events as all of game math is based on game pay tables.

The tickets may be delivered physically or electronically through or at the live sporting event upon which the promotion is based. It is possible, for example, for beer vendors to scan beverage purchases on credit cards, and the credit card company in affiliation with the beverage company, can issue an electronic ticket through an app associated with the credit card and the credit card owner's cell phone or pad. It is felt that an important benefit of this technology is in allowing the client or customer to select which particular game the game card is based on (not just the sport, as the sport might be predetermined by a promotion). Actual game cards or tickets can be relatively novel in their own right, because of content or events. For example, the game cards may be Bingo-type cards with 25 different outcome events in the 25 boxes (and of course there may be a single free space box, as in the center of the card). Other cards may be 3 row by 5 column frames (much like slot machine displays) and winning outcomes are determined according to fixed paylines (such as the top line of 5 frames, the middle line of 5 frames or the bottom line of five frames).

Other conventional and non-conventional paylines may be identified on the ticket itself, as with color schemes or dash lines printed through available paylines. A randomly generated fantasy card may be provided—using buckets of points based on historical data as the determinant in winning event outcomes. The randomly generated parlay card may have a tiered pay table for cash, credit or value of prizes (as opposed to current parlay cards where you a player might have to win all of the bets to win). A randomly generated game score box (e.g., for football, the score box may be a single digit a number for one, each or both teams. If the number is “7” for example, any time having a score ending in “7” at the end of a quarter, or half or third quarter or game would have a winning box. This is different from prior art social games or lotteries having 100 boxes and requiring all of the boxes to be filled, as in the present technology the provided number(s) may be randomly generated or weighted random generation where less likely numbers such as 2, 4 and 8 are offered more frequently to minimize winning outcomes, and only 1 player is required.

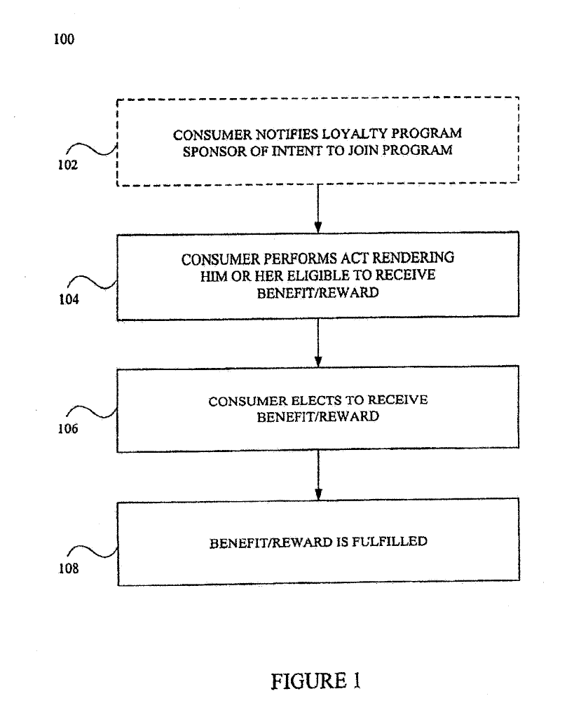

The present disclosure relates to a variety of embodiments related to apparatus and methods of providing an on-site or even distal awards program to consumers. The awards program refers to an award program that provides awards only through randomly generated game tickets or games cards to consumers who purchase goods and services or make an authorized appearance at a commercial facility through a participant or a merchant. This provides an incentive for consumers to visit merchants, and is advantageous to merchants, as consumers who are on-site may purchase more products or services than if they were not located on-site. This effect is enhanced by time intervals in the determination of winning events or results on the game tickets or game cards, which tends to keep customers at the participants' site. Consumers may purchase more goods or services from merchants that participate in an on-site rewards program while waiting for event determinations. However, they do not receive actual rewards for those purchases unless winning event outcomes and results occur which are identified on the cards or tickets. FIG. 1 illustrates one embodiment of a system for providing rewards points, otherwise known as incentive rewards or loyalty points, to consumers who are located on the premises of a participant such as a merchant, sports venue operator, stadium, arena, restaurant, store, outlet, mall, and the like participating in such a rewards program. Such rewards programs are commonly used to encourage consumer purchasing behavior to the benefit of merchants participating in such programs. However, in prior art systems, consumers are generally able to accumulate rewards points no matter if they are located at a participating merchant location or not.

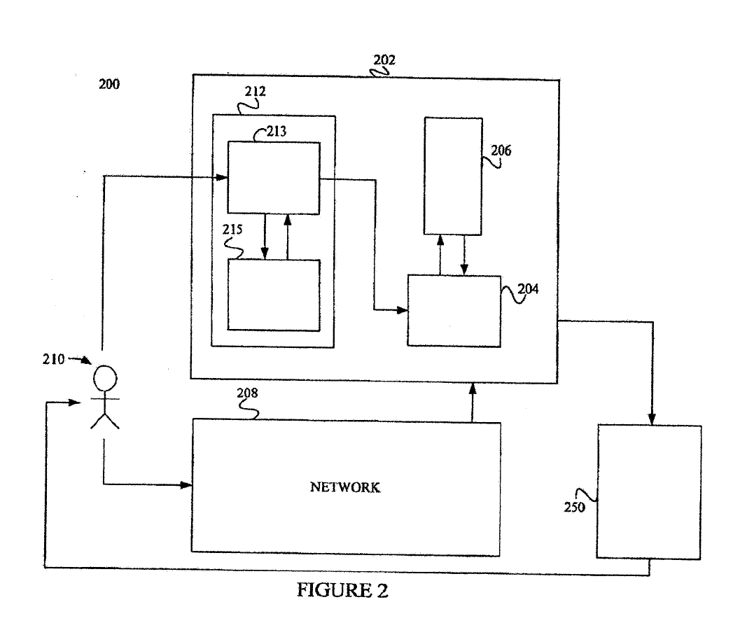

Referring to FIG. 1, consumers each may purchase goods or services from merchants participating in the rewards program using a respective personal communication device 100a, 100b, or 100c. In FIG. 1, each of the personal communication devices 100a, 100b, or 100c are shown located at a participating merchant location 102. For example, each personal communication device may be carried by a respective owner/consumer into a bar, restaurant, sporting event venue, spa, or almost any other merchant of goods or services. The personal communication devices typically comprise a smart phone, such as an iPhone 5 manufactured by Apple Computer, Inc., of Cuppertino, Calif. or a Galaxy S III manufactured by Samsung Electronics of Seoul, South Korea. In other embodiments, personal communication devices may comprise a laptop or tablet computer. In any case, any device may be classified as a personal communication device if it comprises an ability to communicate wirelessly and is able to process purchases for goods or services on behalf of a consumer. Often, the personal communication devices are owned by a single consumer, such as the case where a smartphone is owned by a single person and is generally used exclusively by that person. One or more of the personal communication devices may communicate with a wireless router/modem 104 located on the premises of merchant 102. Wireless router/modem 104 comprises one of any number of commonly available wireless router/modems on the market today, such as a Linksys Smart Wi-Fi Router N600 manufactured by Cisco Systems of San Jose, Calif. Wireless communication signals are passed through router 104 to/from server 106, shown as being located at the merchant 102 location. However, in another embodiment, all or a portion of the services offered by server 106 could be located in a location away from merchant 102, as shown as server 108. For example, in one embodiment, server 106 may offer consumers located on the premises of merchant 102 the ability to order food or drinks, play a musical or video selection on a jukebox or video display located inside the premises of merchant 102, or to play or participate in electronic game play, either individually, or with/against other consumers, while server 108 operates as a game ticket provider or server that issues reward game tickets for electronic or physical delivery to consumers as they purchase goods or services via their personal communication devices while they are located on the premises of the merchant or other participant. A game card account may be created and stored at either server 106 or server 108 to reflect an award balance as awards points are accumulated by each consumer as purchases are made and winning outcomes occur, and to reduce the award balance as consumers use their awards to make future purchases. If server 108 is used, it may communicate with personal communication devices located at merchant 102 via a wide area network 110, such as the Internet, through wireless router/modem/modem 104 located at participant or merchant 102, through server 106 (if used), and then through wireless router/modem 104. Alternatively, or in addition, server 108 may communicate with personal communication devices via a wide area network 110, cellular network 114, then directly to the personal communication devices via a wireless link. In yet another embodiment, server 108 may communicate with personal communication devices cellular network 114 and then to the personal communication devices via a wireless link. In any case, game cards or game tickets (physical or electronic) are awarded to consumers as they purchase goods or services via their personal communication devices only if they are located at a merchant that participates in the rewards points program. Additionally, consumers may, in one embodiment, order goods or services from merchant 102 even if they are not located on the premises of merchant 102, however they are not necessarily given game cards or game tickets for doing so unless they are associated/linked to the promotion through an app or membership. For example, a consumer operating personal communication device 100a may be at home and play a game offered by merchant 102 for a fee or select a musical or audio-visual entertainment selection offered by merchant 102 by accessing server 106 via cellular network 114 which is in communication with server 106 as described above. The location of a personal communication device may be determined by one or more methods, as described in further detail below. FIG. 2 is a functional block diagram of one embodiment of server 108 in an embodiment where server 108 acts as an awards card server or game ticket server and the server 106 acts as a point-of-sale server that receives purchase orders from consumers via personal communication devices and router 104. It should be understood that server 106 typically comprises the same or similar functionality, hardware, and software as server 108.

Specifically, FIG. 2 shows processor 200, memory 202, communication interface 204, and user interface 206. It should be understood that not all of the functional blocks shown in FIG. 2 are required for operation of server 108 (for example, user interface may not be necessary), that the functional blocks may be connected to one another in a variety of ways, and that not all functional blocks necessary for operation of server 108 are shown (such as a power supply), for purposes of clarity. Server 108 may comprise virtually any commercially-available servers on the market today, including the P4300IP server system manufactured by Intel Corporation of Santa Clara, Calif.

Processor 200 provides general operation of server 108 by executing processor-executable instructions stored in memory 202, for example, processor-executable code. Processor 200 typically comprises a general purpose processor, such as any of the Xenon® family of processors manufactured by Intel Corporation of Santa Clara, Calif., although any one of a variety of microprocessors, microcomputers, and/or microcontrollers may be used alternatively. Memory 202 comprises one or more information storage devices, such as hard drives, RAM memories, ROM memories, flash memories, and/or virtually any other type of electronic, optical, or mechanical memory device. Typically, memory 202 comprises more than one type of memory. For example, memory 202 may comprise a ROM memory used to store processor-executable instructions for operation of server 108, plus RAM memory to store customer account information such as award value is achieved from winning outcomes of game tickets or game cards in account for each consumer that is registered to receive award values from server 108. Communication interface 204 is electronically coupled to processor 200 and comprises electronic circuitry necessary for server 108 to communicate with server 106 and, ultimately, personal communication devices. Typically, communication interface 204 comprises hardware, software and/or firmware necessary to transmit and receive information sent via one or more commonly-used network protocols, such as the well-known TCP/IP suite of protocols. Alternatively, or in addition, communication interface could comprise electronics and supporting software/firmware to support other well-known communication types, including Wi-Fi, Bluetooth, wireless telephone communications, fiber-optic communications, and so on. User interface 206 is coupled to processor 200 and is used to allow an individual to control operation of server 108 and/or to receive information from server 108. User interface 206 may comprise one or more keyboards, touchscreen devices, pushbuttons, switches, sensors, keypads, and/or microphones that generate electronic signals for use by processor 200 upon initiation by a user. User interface 206 may additionally comprise one or more display devices, seven-segment displays, cathode ray tubes (CRTs), liquid crystal displays (LCDs), light emitting diode displays (LEDDs), light emitting diodes (LEDs), light arrays, or any other type of visual display. Further, user interface 206 could alternatively or in addition comprise an audio device, such as a speaker, for audible presentation of information to a user. Of course, the aforementioned items could be used alone or in combination with each other and other devices may be alternatively, or additionally, used.

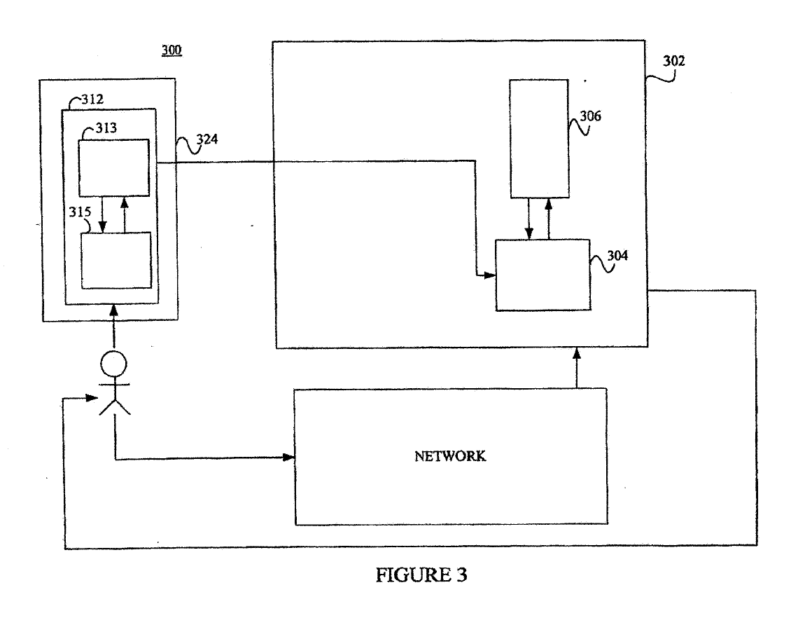

FIG. 3 is a functional block diagram of one embodiment of one of the personal communication devices 100 shown in FIG. 1. Specifically, FIG. 3 shows processor 300, memory 302, communication interface 304, and user interface 306. It should be understood that the functional blocks may be connected to one another in a variety of ways and that not all functional blocks necessary for operation of personal communication device are shown (such as a power supply), for purposes of clarity. Processor 300 provides general operation of personal communication device 100 by executing processor-executable instructions stored in memory 302, for example, executable code. Processor 300 typically comprises a general purpose processor, such as Tegra 2 processor manufactured by Nvidia Corporation of Santa Clara, Calif., although any one of a variety of microprocessors, microcomputers, and/or microcontrollers may be used alternatively. Memory 302 comprises one or more information storage devices, such as hard drives, RAM memories, ROM memories, flash memories, and/or virtually any other type of electronic, optical, or mechanical memory device. Typically, memory 302 comprises more than one type of memory. For example, memory 302 may comprise a ROM memory used to store processor-executable instructions for operation of personal communication device 100, plus RAM memory to store executable code used to allow a user to order goods or services, such as food, drink, music, videos, games, etc. Communication interface 304 is electronically coupled to processor 300 and comprises electronic circuitry necessary for personal communication device 100 to communicate, ultimately, with server 108.

Typically, communication interface 304 comprises hardware, software and/or firmware necessary to transmit and receive information sent via one or more commonly-used network protocols, such as the well-known TCP/IP suite of protocols. Alternatively, or in addition, communication interface could comprise electronics and supporting software/firmware to support a variety of well-known communication types, such as CDMA, TDMA, GSM, Ethernet, Wi-Fi, Bluetooth, fiber-optic communications, and so on. User interface 306 is coupled to processor 300 and is used to allow customers to enter and receive information related to the purchase of goods or services from merchant 102 or a number of other merchants and to receive information regarding rewards points that have been accumulated from previous purchases. User interface 306 may comprise one or more touchscreens, pushbuttons, switches, sensors, keypads, and/or microphones that generate electronic signals for use by processor 300 upon initiation by a user. User interface 306 may additionally comprise one or more liquid crystal displays (LCDs), one or more light emitting diode displays (LEDDs), one or more light emitting diodes (LEDs), light arrays, or any other type of visual display. Further, user interface 306 could, alternatively or in addition, comprise an audio device, such as a speaker, for audible presentation of information to customers. Of course, the aforementioned items could be used alone or in combination with each other and other devices may be alternatively, or additionally, used. Typically, input device 306 comprises a widely-known touchscreen device capable of displaying information and receiving user input.

A consumer may access the user interface of a loyalty platform to control loyalty program parameters other than the nature of the qualifying act. For example, a user may log onto the user interface to determine the identity of the benefit/reward for which he or she is eligible. Thus in accordance with certain embodiments, the user may elect to receive a single, specific benefit, or may select a benefit or a type of benefit from an array of choices such as listed in a catalog. Utilizing the user interface, the user could also determine the particular source of the benefit (i.e. from a particular merchant or manufacturer). Embodiments in accordance with the present invention may even leverage off of existing fields or functionality available to a particular payment processing network, in order to execute the loyalty program. For example, the VisaNet™ payment processing network is configured to include a “reservation file” capability. This capability can be utilized to allow an issuer or other entity to send a file containing individual records that each contain business rules to establish a loyalty offer for individual card numbers. Alternatively, a channel other than VisaNet™ payment messages can be used to transmit the user selections of rewards parameters to a loyalty platform, with separate file types defined for receiving this information delivered via another, secure channel.

Another example of a game ticket technology is with respect to competition in individual player sports, such as tennis, bowling or golf, which tickets may be selected by players according to their sports interests. For example, in a sports gaming ticket, using golf as an example, there are anywhere from 50 players to 200+ plus players in a tournament. The random number generator will assign numbers (or symbols to each player) and randomly selected one or (preferably) more players, such as four players. Individual players may be weighted in their random selection (as indicated above), with higher favored players given lower probabilities of being randomly drawn. Players cards may have uniform payout odds (for a first place, 1st and 2d place, 1st, 2d and 3d place finish, or all four place finishes or other combinations. Awards may also be tailored to the game events.

With golf for example, gifts mat be as small as a bag of tees, or as large as tickets to a local PGA tournament, with intermediate ranges of golf towels, golf balls, a golf club(s)or passes to a local golf course, First round tickets with specific numbers of players that make the cut in a tournament, yet are not high in strategic position to win may exchange that ticket for another random draw with only other players that made the cut, but with reduced odds or with potential top prizes excluded by the exchange. A basis of winning in individual sports games, or even team sports games where individual scoring is recorded (e.g., football, golf, hockey, basketball, baseball, soccer, etc.), the collective scores of the individual players on the randomly selected group of players may also be totaled and compared. With golf, the lowest total scores may be used as a winning target, and in other games, the highest score (except for goals against in Hockey, or ERA in baseball for pitchers) would ordinarily be used. Players needs not be in the same grouping for golf nor on the same teams or even leagues in other sports. Scoring may be done on individual rounds of play, individual weeks of play (less desirable because of the delay in awards) or in specific tournaments. Prizes may be general and non-specific to a particular sport, such as a free beverage, discount at the casino restaurant(s), reduced room rate or other award. These and other variations may be provided by those skilled in the art without deviating from the scope of the disclosed invention.

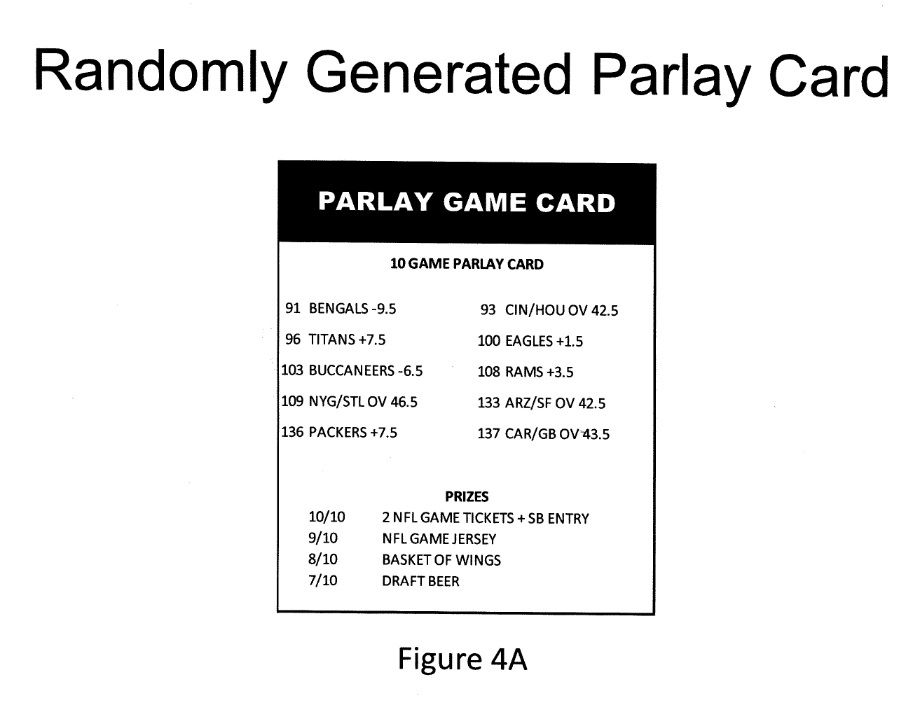

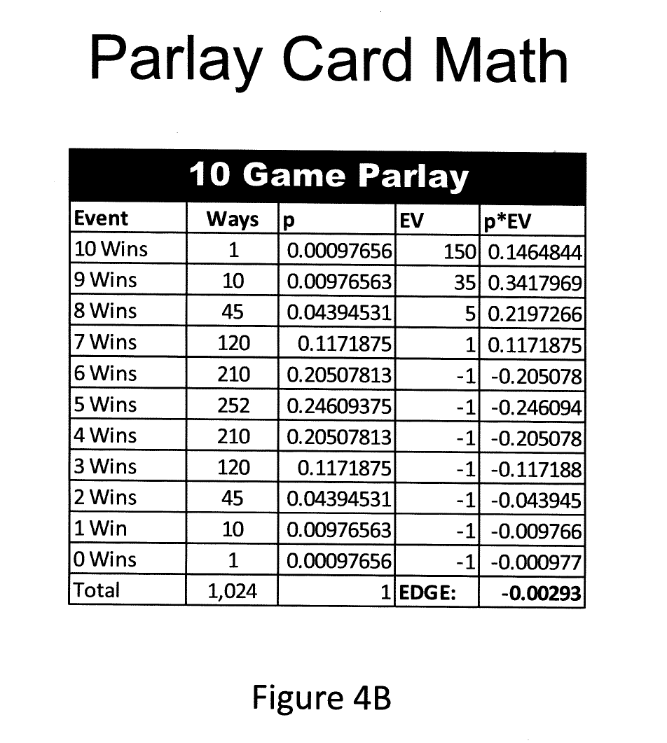

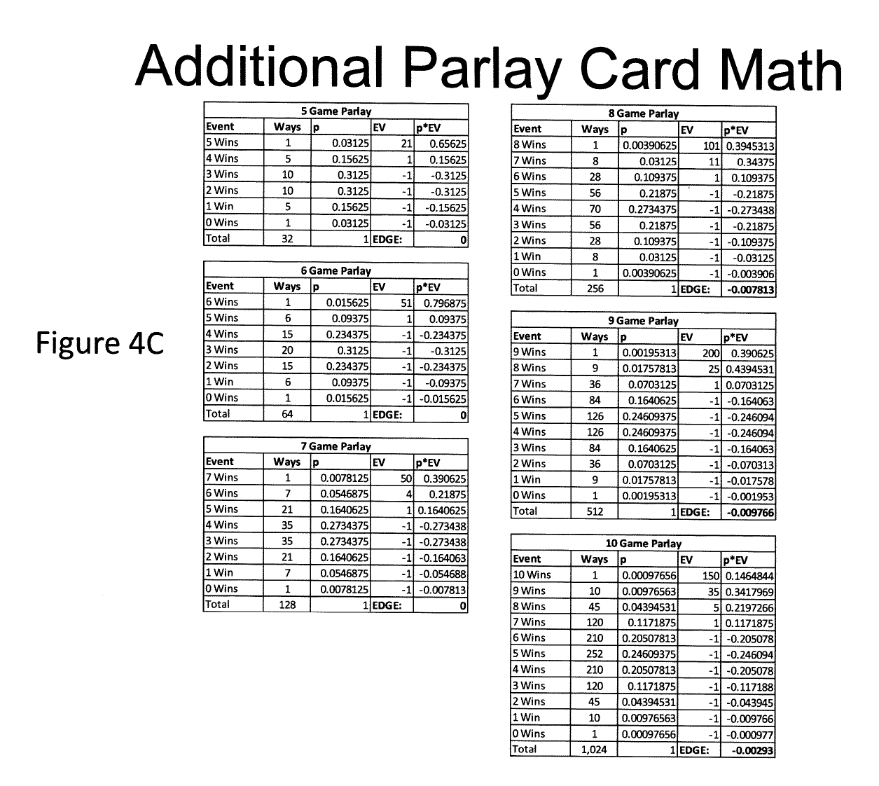

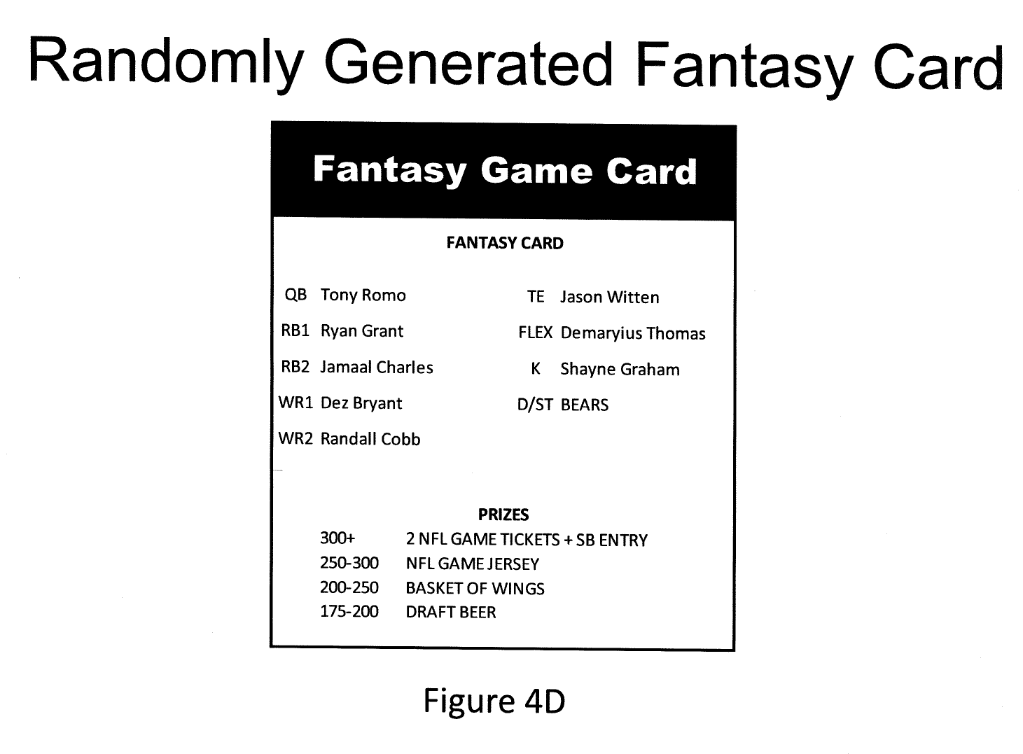

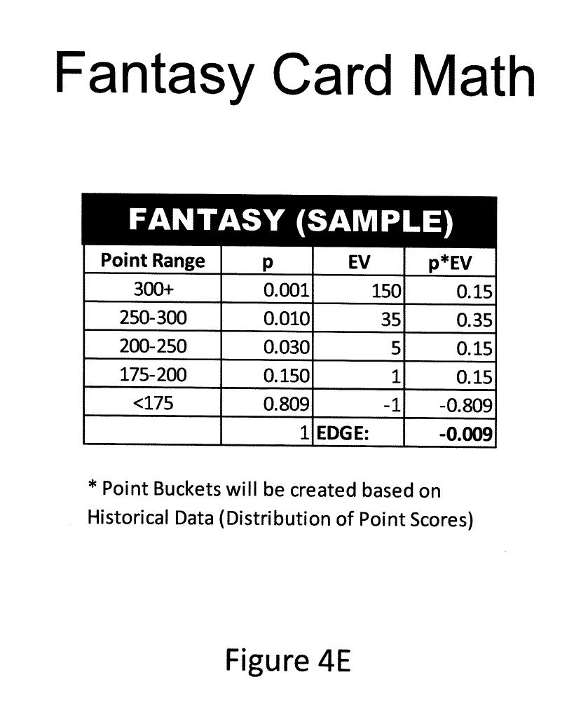

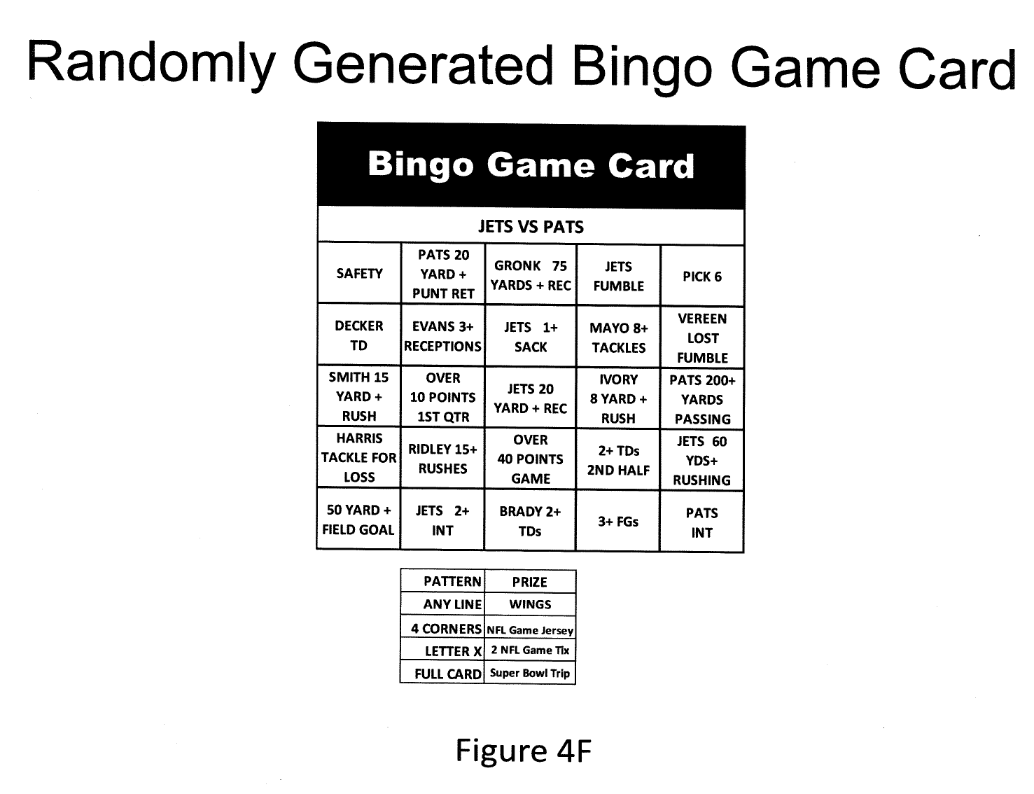

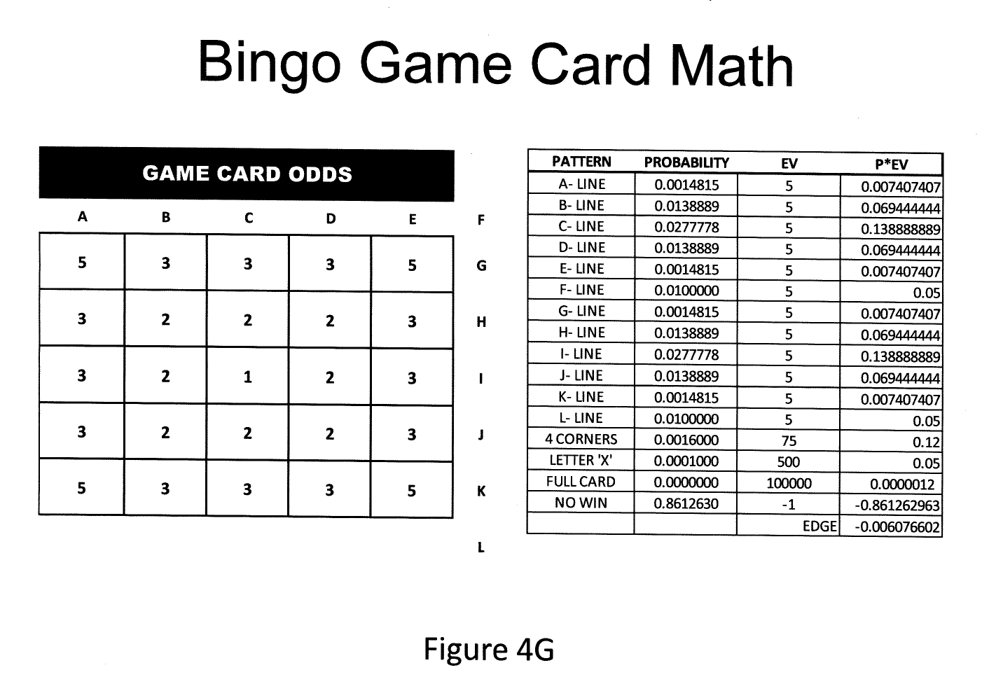

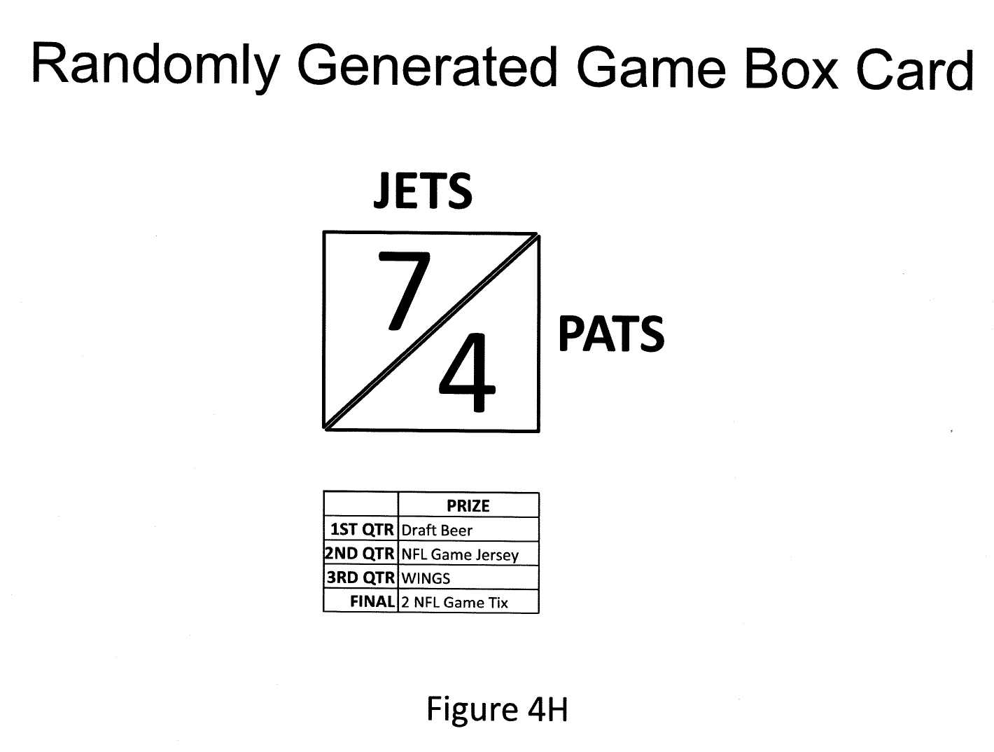

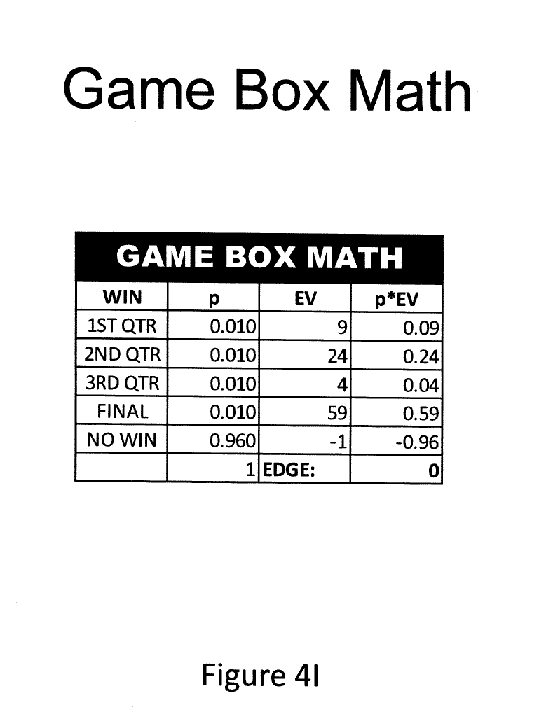

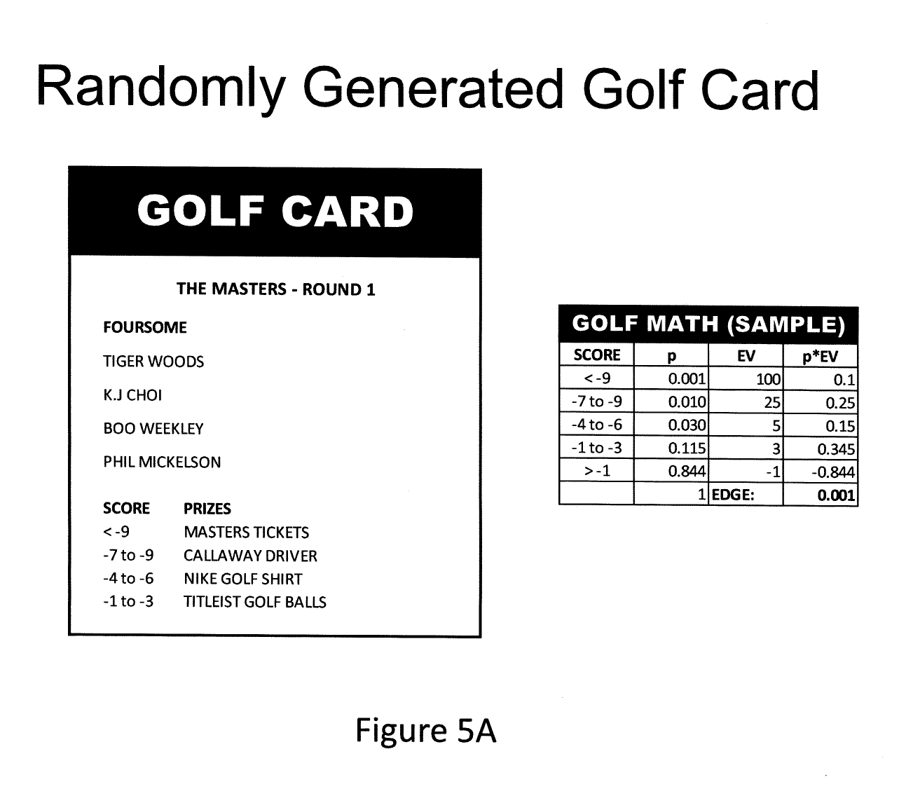

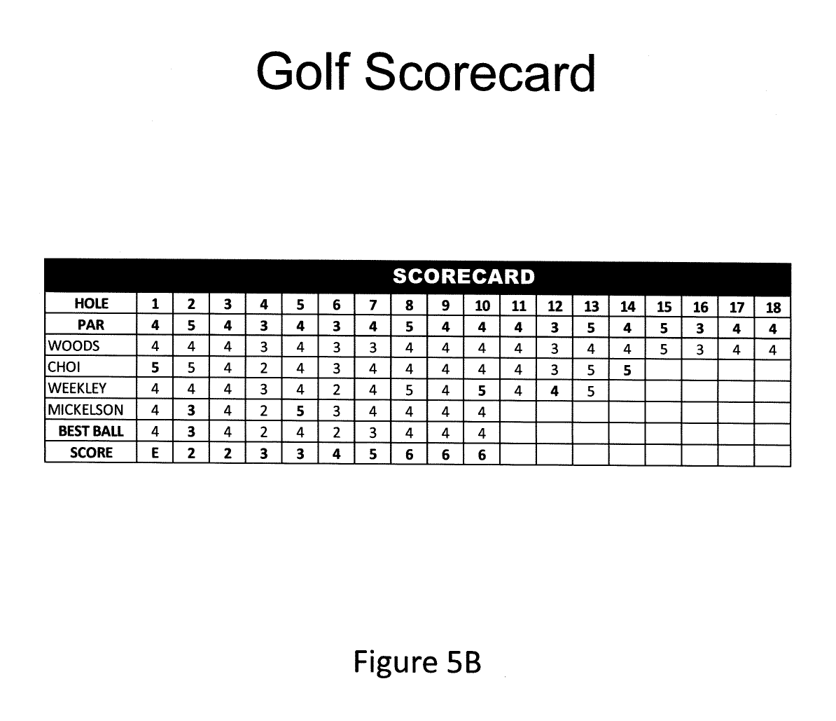

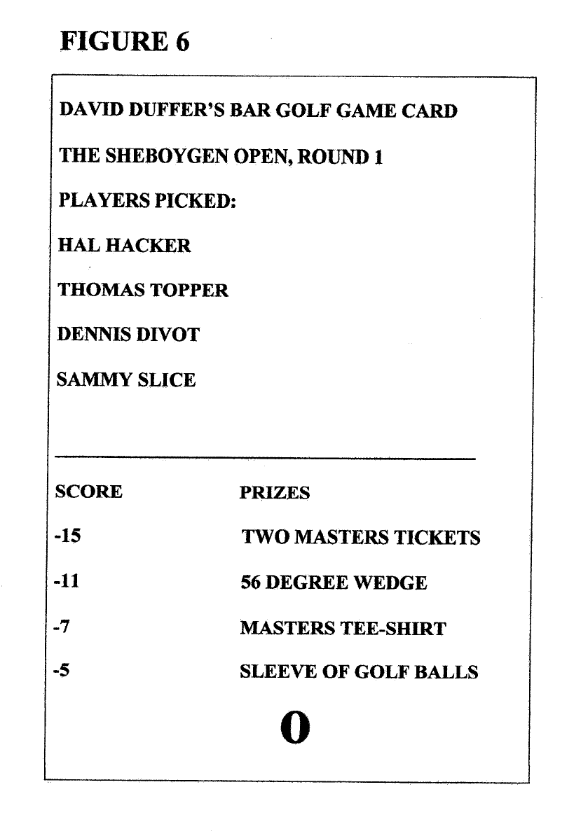

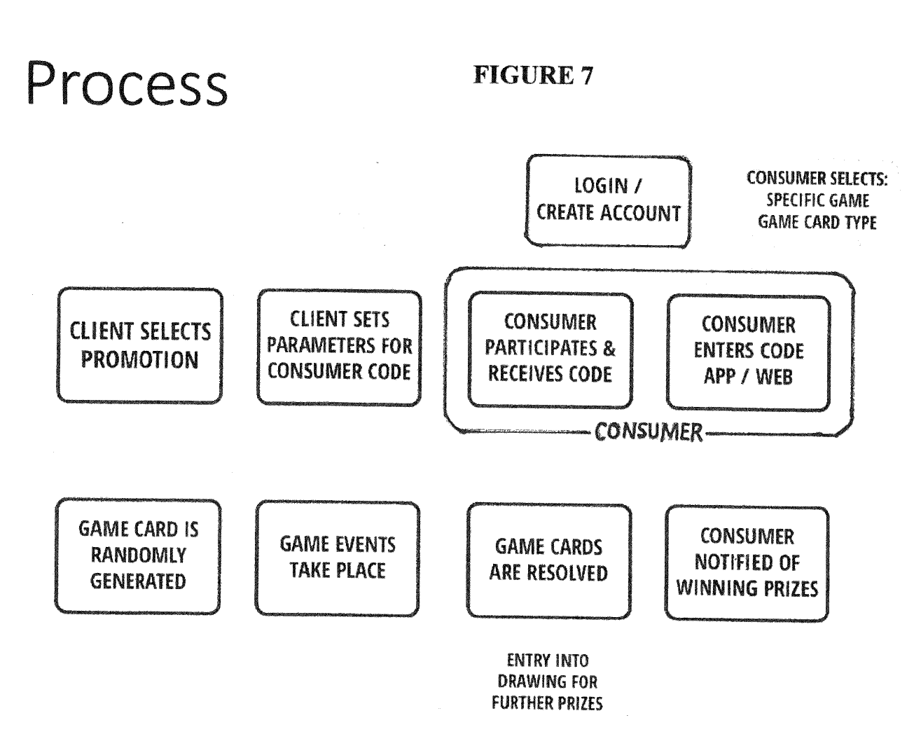

FIG. 4A is a sample of a Parlay Game card that may be a ticket or an image.

FIG. 4B is a math analysis of the Parlay Game card of FIG. 4A.

FIG. 4C shows additional math analyses for Parlay Game cards different from that in FIG. 4A.

FIG. 4D shows a sample Randomly Generated Fantasy Card. FIG.

4E is a math analysis of the Fantasy Game card of FIG. 4D.

FIG. 4F is a sample of a Randomly Generated Bingo-type Game card.

FIG. 4G is a math analysis of a Randomly Generated Bingo-type Game card as in 4F.

FIG. 4H is a sample of a Randomly Generated Game Box card.

FIG. 4I is a math analysis of a Randomly Generated Game Box card as in 4H.

FIG. 5A is a sample of a random draw of four players (the Virtual

Foursome), a list of exemplary prizes and a separate indication of probabilities in outcomes.

5B is a partially completed scorecard for the virtual foursome at a tournament.

FIG. 6 is a screen shot of an electronically transmitted award based on a fictitious golf event. The ticket contains, for example, a random selection of four players for a virtual foursome. The players do not have to actually be in the same foursome. At the end of the round (the selection may even be made mid-round, when partial scores of players are known), the total score of the four player relative to par are totaled. If they achieve different levels indicated on the card, the indicated prize is won. By allowing the distal processor to randomly select players/teams, even while games are going on, or in the case of a day's series of games 9 as on a college football, Saturday), random games and random outcomes may even be selected during or after the games. Therefore, “real-time” has a potential content of reaching back into recent events as well as extending forward as indicated earlier herein. As long as the selections are random, including both target “points” or events, the system exhibits a fair offer to users/customers.

One embodiment of a process within the generic scope of the present technology is schematically shown in FIG. 7. A particular client/user/person/establishment logs in to the system and/or creates an account. A random game ticket is provided, with an optional weighting of the type of game card provided by player selection such as “football game card,” NBA game card, SEC football game card, PGA golf card, NHL hockey card, etc. The client (which is the prize provider/manufacturer/sports league, etc.) selects the type of promotion that is to be offered. The client sets parameters for the consumer (card distributor) code. The consumer participates in the service and receives a code for using the ticket award provision system over a given time period. The consumer then asks for individual random event game card by accessing code and sends code to distal server. The game card is electronically randomly generated, either as a printed physical card, virtual electronic card sent to and stored on a mobile device (pad, phone, PC, laptop, etc.) or a terminal (even a wagering terminal where allowed). Upon conclusion of all game events within the “real-time” period allotted to the card, the point/outcome events are provided to the distal server. The distal server then resolves winning outcomes and losing outcomes on the cards. Where the cards are virtual cards, the server can directly notify the card-holder through the on-line electronic device storing the virtual card. Where printed tickets are provided, the tickets may be scanned (e.g., through bar code, QR, etc.) and outcomes verified. Or a central display at the ticket-providing site can display winning ticket numbers, such as “Patron 736, card number A-726-BP-36 is a WINNER.”

Partial winners, such as another FREE TICKET can be provided as an outcome.

What is claimed:

1. A method of providing random potential award identifiers to users without purchase comprising: a) a primary client enabling provision of game cards having a potential for obtaining awards based on random event outcomes; b) the primary client establishing a supply system for the users to obtain the game cards; c) the user engaging in the supply system through a local processor and the local processor obtaining a unique identification code enabling access to a client controlled source of game cards; d) the user accesses through the local processor a distal server and enters the unique identification code; e) the distal server provides a randomly generated game card to the local processor having a potential for obtaining awards based on random event outcomes without the user exchanging value to obtain the randomly generated game card; f) information is provided to the distal server of random event outcomes; and g) the server identifying winning or losing outcomes based on a comparison of information content identified on the randomly generated game card and the random event outcomes.

2. The method of claim 1 wherein the random event outcomes are sports event outcomes or statistics.

3. The method of claim 2 wherein the user selects a general field of sports events, particular game in a field of sports and the processor then provides the card with random event outcomes within the selected field or particular game.

4. The method of claim 3 wherein the user selects a general field selected from the group consisting of football, basketball, baseball, hockey, soccer, golf, horse racing, automobile racing and tennis.

5. The method of claim 4 wherein event outcomes or statistics within the general field must be determined within ±48 hours of award of randomly generated game cards.

6. The method of claim 4 wherein event outcomes or statistics within the general field must be determined within ±24 hours of award of randomly generated game cards.

7. The method of claim 1 wherein the primary client is a retailer, wholesaler, sports venue operator, stadium, arena, movie theater, restaurant, bar, retail store or online sales business.

8. The method of claim 4 wherein the primary client is a retailer, wholesaler, restaurant, sports venue operator, stadium, arena, track or online sales business.

9. The method of claim 5 wherein the primary client is a retailer, wholesaler, restaurant, sports venue operator, stadium, arena, track or online sales business.

10. The method of claim 2 wherein the user resolves the randomly awarded game ticket by online communication to the server after conclusion of the random event outcomes, which random event outcomes must occur within ±12 hours of ticket awarding, and resolution of winning outcomes is provided by online downloadable or printable coupons that can be redeemed.

11. The method of claim 3 wherein the user resolves the randomly awarded game ticket by online communication to the server after conclusion of the random event outcomes, which random event outcomes must occur within ±4 hours of ticket awarding, and resolution of winning outcomes is provided by online downloadable or printable coupons that can be redeemed.

12. The method of claim 4 wherein the user resolves the randomly awarded game ticket by online communication to the server after conclusion of the random event outcomes, which random event outcomes must occur within ±6 hours of ticket awarding, and resolution of winning outcomes is provided by online downloadable or printable coupons or QR code that can be redeemed.

13. The method of claim 6 wherein the user resolves the randomly awarded game ticket by online communication to the server after conclusion of the random event outcomes and resolution of winning outcomes is provided by online downloadable or printable coupons that can be redeemed.

14. The method of claim 8 wherein the user resolves the randomly awarded game ticket by online communication to the server after conclusion of the random event outcomes and resolution of winning outcomes is provided by online downloadable or printable coupons that can be redeemed through the retailer, wholesaler, restaurant, sports venue operator, stadium, arena, or online sales business.

15. The method of claim 13 wherein the ticket or coupon comprises a scannable QR code.

16. The method of claim 1 wherein the distal server provides the game card by accessing real time sports line probabilities and sports data to create the randomly generated game cards.

17. The method of claim 11 wherein the distal server provides the game card by accessing real time sports line probabilities and sports data to create the randomly generated game cards and the game code is accessible using a scannable QR code on the game card.

18. A method of providing random potential award identifiers to users without purchase comprising: a) a primary client enabling provision of game cards having a potential for obtaining awards based on random event outcomes; b) the primary client establishing a supply system for the users to obtain the game cards; c) the user engaging in the supply system through a local processor and the local processor obtaining a unique identification code enabling access to a client controlled source of game cards; d) the user accesses through the local processor a distal server and enters the unique identification code; e) the distal server provides a randomly generated game card to the local processor having a potential for obtaining awards based on random event outcomes without the user exchanging value specifically to obtain the randomly generated game card; f) information is provided to the distal server of random event outcomes within 2 hours of the random event outcome; and g) the server identifying winning or losing outcomes based on a comparison of information content identified on the randomly generated game card and the random event outcomes, wherein the random event outcomes are sports event outcomes or statistics, and the ticket is issued after at least one sports event has begun or been concluded.

19. The method of claim 18 wherein a player obtains rights to a card more than 48 hours before the random event providing the outcome is started, and the ticket is issued to the player within ±2 hours of the starting of the random event.

20. The method of claim 2 wherein a player obtains rights to a card more than 48 hours before the random event providing the outcome is started, and the ticket is issued to the player within ±2 hours of the starting of the random event.
